(19) United States
(12) Patent Application Publication
(10) Pub. No.: US 2023/0172115 A1
(43) Pub. Date: Jun. 8, 2023

(54) LIGHTING SYSTEM AND METHOD FOR USE IN VERTICAL HYDROPONICS

(71) Applicant: Eden Green US & Caribbean Produce Holdings Inc., Cleburne, TX (US)

(72) Inventors: Jacques van Buuren, Cleburne, TX (US); Eugene van Buuren, Cleburne, TX (US)

(73) Assignee: Eden Green US & Caribbean Produce Holdings Inc., Cleburne, TX (US)

(21) Appl. No.: 18/077,359

(22) Filed: Dec. 8, 2022

Related U.S. Application Data
(60) Provisional application No. 63/287,232, filed on Dec. 8, 2021.

(51) Int. Cl. A01G 7/04; A01G 31/02

(52) U.S. Cl. CPC A01G 7/045; A01G 31/02

(57) ABSTRACT

An adjustable lighting system and method are used to provide uniform exposure of light to plants in a vertical hydroponics system. The system and method utilize sensors, an adjustable lighting arrangement, and a microcontroller. The microcontroller measures light intensity within the vertical hydroponics system and adjusts the illumination of the lighting arrangement to provide an equal amount of illumination to the plants.

### FIELD OF THE INVENTION

This application claims priority to U.S. Provisional Pat. App. Serial No. 63/287,232, filed Dec. 8, 2021, entitled “Lighting System and Method for Use in Vertical Hydroponics,” the entire contents of which are hereby incorporated by reference.

This disclosure relates to vertical hydroponics. In particular, the disclosure relates to an adjustable lighting system and a method of providing a uniform luminous exposure of light in a vertical hydroponics system, over a period of time.

### BACKGROUND

The cultivation of plants in vertical hydroponic systems, is a space efficient way of producing crops. These vertical hydroponic systems comprise of vertically extending growth tubes that contain plants at intervals over the height of each growth tube.

However, as natural- and artificial light is predominantly received from above, exposure to light over the height of the vertical hydroponic system is not uniform. This can lead to uneven crop growth.

It is an object of the present disclosure to address this problem.

### SUMMARY

Broadly, according to one aspect of preferred embodiments described herein, there is provided an adjustable lighting system, which includes
a plurality of sensors disposed at various intervals over the height of a vertically extending hydroponic growth tube for measuring light intensity at various heights of the growth tube;
an adjustable lighting arrangement, operable to adjust the light intensity at various heights of the vertically extending hydroponic growth tube; and
a microcontroller connected to the sensors for reading the measured light intensity at the various heights of the vertically extending hydroponic growth tube, the microcontroller connected to the adjustable lighting arrangement for adjusting the illumination of the lighting arrangement to provide an equal amount of illumination to plants over the height of the vertically extending hydroponic growth tube.

In one embodiment, the adjustable lighting arrangement is in the form of a mechanically displaceable lighting system, which includes
at least one light;
a hoisting device attached to the at least one light for adjusting the vertical position of the at least one light along the height of the vertically extending growth tube, the microcontroller controllably connected to the hoisting device for adjusting the vertical position of the light depending on the light intensity measured by the plurality of sensors.

The hoisting device may be supported by means of a supporting structure, such as a greenhouse, a loose standing frame, or the like.

In one embodiment, the vertically extending hydroponic growth tube may be arranged in a plurality of parallel rows, defining an array of growth tubes, disposed within a housing. The housing may be a greenhouse, a loose standing frame or other suitable structure.

In use, the hoisting device may be retrofitted onto the supporting structure on an overhead position relative to the array of growth tubes.

The hoisting device may be in the form of a winch connected to a rotatable shaft over which a support rope is rolled.

The hoisting device may include a drive member operable to adjust the vertical position of the at least one light. The microcontroller may be connected to the drive member, allowing the microcontroller to control the actuation of the hoisting device.

The drive member may be in the form of a motor or the like.

The at least one light may be attached to the hoisting device by means of a tensile element.

The tensile element may be in the form of a rope, cable, wire or the like.

In an embodiment in which the hoisting device is in the form of a rotatable shaft, the at least one light may be suspended therefrom, whereby the rotation of the shaft results in an opposite winding up and winding down rotation of the tensile element, thereby adjusting the vertical position of at least one light.

The at least one light may be orientated to direct illumination towards a portion of at least one vertical planar surface. In one embodiment, the at least one vertical planar surface is defined by a row of vertically extending growth tubes.

The at least one light may be in the form of a full spectrum plant light, light-emitting diode (LED) grow light or the like.

The microcontroller may be programmed to ensure a uniform luminous exposure over the height of the vertically extending growth tube over a period of time.

The microcontroller may include a memory capable of storing instructions thereon, which instructions may include algorithms for adjustment of the vertical position or the luminous exposure of the at least one light along the height of the vertically extending growth tube or both.

According to another aspect of preferred embodiments described herein there is provided a method of providing a uniform luminous exposure of light in a vertical hydroponics system, over a period of time, which includes
employing an adjustable lighting system, as described;
measuring light intensity at various intervals over the height of the vertically extending growth tube, by means of a plurality of sensors;
calculating an amount of light intensity required to grow plants, which plants are disposed at the various intervals over the height of the vertically extending growth tube;
adjusting of the adjustable lighting arrangement in order for the measured light intensity to match the amount of light intensity required to grow the plants.

Both steps of measuring light intensity and calculating the amount of light intensity required may be conducted over the same period of time.

The preferred embodiments of the lighting system and method are now described, by way of non-limiting example, with reference to the accompanying figures:

### BRIEF DESCRIPTION OF THE DRAWINGS

FIG. 1 shows an adjustable lighting system in accordance with one aspect of the invention; and

FIG. 2 shows a front view of an adjustable lighting system in accordance with one aspect of the invention.

In the figures, like reference numerals denote like parts of the invention unless otherwise indicated.

### DETAILED DESCRIPTION OF PREFERRED EMBODIMENTS

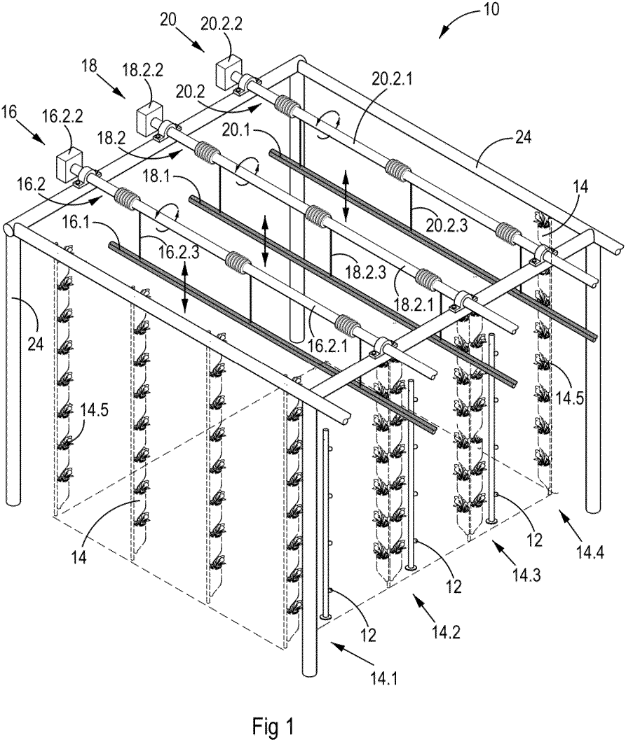

FIG. 1 depicts a preferred embodiment of an adjustable lighting system (10) which includes a plurality of sensors (12) disposed at various intervals over the height of a vertically extending hydroponic growth tube (14) for measuring light intensity at various heights of the vertically extending hydroponic growth tube (14) and adjustable lighting arrangements (16, 18, 20) operable to adjust the light intensity at various heights of the vertically extending hydroponic growth tube (14).

In this embodiment, a plurality of vertically extending hydroponic growth tubes (14) are arranged in parallel rows (14.1, 14.2, 14.3, 14.4), thereby defining an array of growth tubes (14), which array of growth tubes (14) are surrounded by a supporting structure (24).

Furthermore, the adjustable lighting system (10) may include in some embodiments a microcontroller (not pictured) connected to the plurality of sensors (12) for reading the measured light intensity at the various heights of the vertically extending hydroponic growth tubes (14). The microcontroller is connected to the adjustable lighting arrangements (16, 18, 20) for adjusting the illumination of the adjustable lighting arrangements (16, 18, 20) to provide an equal amount of illumination to plants (14.5) arranged over the height of the vertically extending hydroponic growth tubes (14).

In this embodiment, the adjustable lighting arrangements (16, 18, 20) are in the form of a mechanically displaceable lighting system, which include three lights (16.1, 18.1, 20.1) each attached to a hoisting device (16.2, 18.2, 20.2) for adjusting the vertical position of each light (16.1, 18.1, 20.1) along the height of the vertically extending hydroponic growth tubes (14). Furthermore, the microcontroller is controllably connected to each hoisting device (16.2, 18.2, 20.2) for adjusting the vertical position of each light (16.1, 18.1, 20.1) depending on the light intensity measured by the plurality of sensors (12).

The lights (16.1, 18.1, 20.1) in this embodiment in the form of light-emitting diode (LED) growth lights, capable of providing light (22) for the plants (14.5) required for photosynthesis.

It is to be appreciated that, the measured light intensity refers to amount of illumination (22) provided to each plant (14.5) by means of the lights (16.1, 18.1, 20.1) and an amount of natural light exposure, to which each plant (14.5) is exposed to.

Each hoisting device (16.2, 18.2, 20.2) is supported by means of the supporting structure (24), which in this embodiment is in the form of a framed structure, whereby the hoisting devices (16.2, 18.2, 20.2) are arranged parallel relative to the parallel rows (14.1, 14.2, 14.3, 14.4), thereby allowing for the lights (16.1, 18.1, 20.1) to be positioned between the parallel rows (14.1 and 14.2, 14.2 and 14.3, 14.3 and 14.4), respectively.

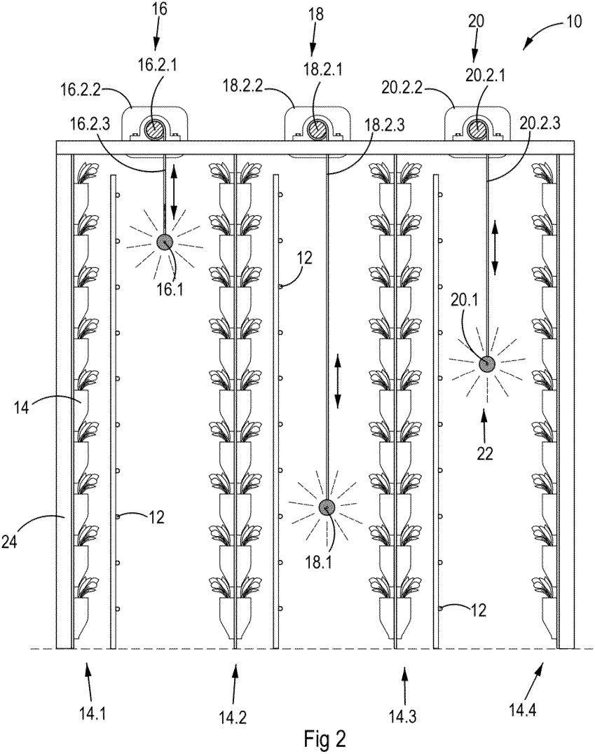

FIG. 2 depicts a preferred embodiment of the lighting system (10) described herein in which the lights (16.1, 18.1, 20.1) are all positioned at different heights between the parallel rows (14.1, 14.2, 14.3, 14.4), as a result of different luminous exposure of light required by the plants (14.5). For example, the plants (14.5) arranged at a top portion of the vertically extending hydroponic growth tubes (14) between the rows (14.1, 14.2), requires an additional illumination (22) via the light (16.1) than the plants (14.5) arranged at a mid - and lower portion of the vertically extending hydroponic growth tubes (14.5).

As shown in FIGS. 1 and 2, in preferred embodiments each hoisting device (16.2, 18.2, 20.2) can be in the form of a winch, which comprise of a drive member (16.2.2, 18.2.2, 20.2.2) connected to a rotatable shaft (16.2.1, 18.2.1, 20.2.1) over which a support rope (16.2.3, 18.2.3, 20.2.3) is rolled. In use, the drive members (16.2.2, 18.2.2, 20.2.2) are capable of rotating the rotatable shafts (16.2.1, 18.2.1, 20.2.1), respectively.

The support ropes (16.2.3, 18.2.3, 20.2.3) comprise of a tensile element, which in this embodiment is in the form of a cable.

The drive members (16.2.2, 18.2.2, 20.2.2) in this embodiment are in the form of motors, operable to adjust the vertical position of the lights (16.1, 18.1, 20.1), through the rotation of the rotatable shafts (16.2.1, 18.2.1, 20.2.1). Furthermore, the microcontroller (not pictured) may be connected to the motors (16.2.2, 18.2.2, 20.2.2), thereby allowing the microcontroller to control the actuation of the hoisting devices (16.2, 18.2, 20.2).

Each light (16.1, 18.1, 20.1) in this embodiment is attached via the cables (16.2.3, 18.2.3, 20.2.3) to the rotatable shafts (16.2.1, 18.2.1, 20.2.1), thereby suspending the lights (16.1, 18.1, 20.1) from the rotatable shafts (16.2.1, 18.2.1, 20.2.1) between the parallel rows (14.1 14.2, 14.3, 14.4).

It is to be appreciated that in this embodiment the rotation of the rotatable shafts (16.2.1, 18.2.1, 20.2.1) results in winding up and winding down of the cables (16.2.3, 18.2.3, 20.2.3), thereby adjusting the vertical position of the lights (16.1, 18.1, 20.1) relative to the vertically extending hydroponic growth tubes (14). In use, rotation of the rotatable shafts (16.2.1, 18.2.1, 20.2.1) in one direction will result in the lights (16.1, 18.1, 20.1) moving in an upwards direction, whereby rotation of the rotatable shafts (16.2.1, 18.2.1, 20.2.1) in an opposed direction will result in the lights (16.1, 18.1, 20.1) moving in a downwards direction.

Each light (16.1, 18.1, 20.1) is orientated to direct illumination (22) onto the vertically extending growth tubes (14). In use, the microcontroller may be programmed to ensure a uniform luminous exposure over the height of the vertically extending hydroponic growth tubes (14) over a period of time.

Furthermore, the microcontroller may include a memory capable of storing instructions thereon, which instructions includes algorithms for adjustment of the vertical position and/or luminous exposure (22) of the lights (16.1, 18.2, 20.1) along the height of the vertically extending hydroponic growth tubes (14).

In use, the uniform luminous exposure of light onto the plants (14.5), which comprise of the illuminations (22) via the lights (16.1, 18.1, 20.1) and the exposure of natural sunlight onto the plants (14.5) over a period of time is achieved by measuring the light intensity at various intervals over the height of the vertically extending hydroponic growth tubes (14), by means of the plurality of sensors (12). Thereafter, calculating an amount of light intensity required to grow the plants (14.5) and accordingly adjusting the mechanically displaceable lighting system (16, 18, 20), thereby adjusting the vertical position or luminous exposure (22) of the lights (16.1, 18.2, 20.1) along the height of the vertically extending hydroponic growth tubes (14), in order for the measured light intensity to match the amount of light intensity required to grow the plants (14.5).

The lighting system and method described herein provide uniform exposure of light to plants in a vertical hydroponics system.

Preferred embodiments disclosed herein relate to an adjustable lighting system comprising a plurality of sensors disposed at various intervals over the height of a vertically extending hydroponic growth tube for measuring light intensity at various heights of the growth tube, an adjustable lighting arrangement, operable to adjust the light intensity at various heights of the vertically extending hydroponic growth tube, and a microcontroller connected to the sensors for reading the measured light intensity at the various heights of the vertically extending hydroponic growth tube, the microcontroller connected to the adjustable lighting arrangement for adjusting the illumination of the lighting arrangement to provide an equal amount of illumination to plants over the height of the vertically extending hydroponic growth tube.

In additional preferred embodiments, the adjustable lighting arrangement is in the form of a mechanically displaceable lighting system, which comprises at least one light and a hoisting device attached to the at least one light for adjusting the vertical position of the at least one light along the height of the vertically extending growth tube, the microcontroller controllably connected to the hoisting device for adjusting the vertical position of the light depending on the light intensity measured by the plurality of sensors.

In further preferred embodiments, the at least one light is orientated to direct illumination onto the vertically extending hydroponic growth tube. In additional preferred embodiments, the hoisting device is a winch.

Additional preferred embodiments relate to an adjustable lighting system as described above, comprising a plurality of vertically extending hydroponic growth tubes. In additional preferred embodiments the adjustable lighting system may comprise a supporting structure, wherein the plurality of vertically extending hydroponic growth tubes are arranged in parallel rows defining an array of growth tubes, and wherein the array of growth tubes are surrounded by the supporting structure.

In further preferred embodiments, the adjustable lighting arrangement included in the adjustable lighting system is in the form of a mechanically displaceable lighting system comprising a plurality of lights and a plurality of hoisting devices, wherein the hoisting devices are attached to the lights for adjusting the vertical position of the lights along the height of the vertically extending growth tubes, wherein the hoisting devices are attached to the supporting structure and are arranged parallel relative to the parallel rows of the growth tubes, and wherein the microcontroller is controllably connected to the hoisting devices for adjusting the vertical position of the lights depending on the light intensity measured by the plurality of sensors. In further preferred embodiments, the lights are positioned at different heights between the parallel rows.

Additional preferred embodiments disclosed herein relate to a method of providing a uniform luminous exposure of light in a vertical hydroponics system, over a period of time, comprising employing an adjustable lighting system according to preferred embodiments disclosed herein in the vertical hydroponics system, wherein the vertical hydroponics system comprises plants, measuring light intensity at various intervals over the height of the vertically extending growth tube, by means of a plurality of sensors, calculating an amount of light intensity required to grow the plants, which plants are disposed at the various intervals over the height of the vertically extending growth tube, and adjusting of the adjustable lighting arrangement in order for the measured light intensity to match the amount of light intensity required to grow the plants.

What is claimed is:

1. An adjustable lighting system, comprising:
at least one vertically extending hydroponic growth tube;
a plurality of sensors disposed at various intervals over the height of the at least one vertically extending hydroponic growth tube for measuring light intensity at various heights of the growth tube;
an adjustable lighting arrangement, operable to adjust the light intensity at various heights of the at least one vertically extending hydroponic growth tube; and
a microcontroller connected to the sensors for reading the measured light intensity at the various heights of the at least one vertically extending hydroponic growth tube, the microcontroller connected to the adjustable lighting arrangement for adjusting the illumination of the lighting arrangement to provide an equal amount of illumination to plants over the height of the at least one vertically extending hydroponic growth tube.

2. The adjustable lighting system of claim 1, wherein the adjustable lighting arrangement is in the form of a mechanically displaceable lighting system, which comprises:
at least one light; and
a hoisting device attached to the at least one light for adjusting the vertical position of the at least one light along the height of the vertically extending growth tube, the microcontroller controllably connected to the hoisting device for adjusting the vertical position of the light depending on the light intensity measured by the plurality of sensors.

3. The adjustable lighting system of claim 2, wherein the at least one light is orientated to direct illumination onto the vertically extending hydroponic growth tube.

4. The adjustable lighting system of claim 2, wherein the hoisting device is a winch.

5. The adjustable lighting system of claim 1, comprising a plurality of vertically extending hydroponic growth tubes.

6. The adjustable lighting system of claim 5, further comprising a supporting structure, wherein the plurality of vertically extending hydroponic growth tubes are arranged in parallel rows defining an array of growth tubes, and wherein the array of growth tubes are surrounded by the supporting structure.

7. The adjustable lighting system of claim 6, wherein the adjustable lighting arrangement is in the form of a mechanically displaceable lighting system comprising a plurality of lights and a plurality of hoisting devices, wherein the hoisting devices are attached to the lights for adjusting the vertical position of the lights along the height of the vertically extending growth tubes, wherein the hoisting devices are attached to the supporting structure and are arranged parallel relative to the parallel rows of the growth tubes, and wherein the microcontroller is controllably connected to the hoisting devices for adjusting the vertical position of the lights depending on the light intensity measured by the plurality of sensors.

8. The adjustable lighting system of claim 7, wherein the lights are positioned at different heights between the parallel rows.

9. A method of providing a uniform luminous exposure of light in a vertical hydroponics system, over a period of time, comprising:
employing the adjustable lighting system of claim 1 in the vertical hydroponics system, wherein the vertical hydroponics system comprises plants;
measuring light intensity at various intervals over the height of the vertically extending growth tube, by means of a plurality of sensors;
calculating an amount of light intensity required to grow the plants, which plants are disposed at the various intervals over the height of the vertically extending growth tube;
adjusting of the adjustable lighting arrangement in order for the measured light intensity to match the amount of light intensity required to grow the plants.
